(19) United States
(12) Patent Application Publication
(10) Pub. No.: US 2019/0092141 A1
(43) Pub. Date: Mar. 28, 2019

(54) AIR VENT FOR A VEHICLE

(71) Applicant: ILLINOIS TOOL WORKS INC., Glenview, IL (US)

(72) Inventor: Marek PESTA, Jablonec nad Nisou (CZ)

(21) Appl. No.: 16/129,031

(22) Filed: Sep. 12, 2018

(30) Foreign Application Priority Data
Sep. 22, 2017 (DE) 10 2017 122 039.9

(51) Int. Cl. B60H 1/34

(52) U.S. Cl. CPC B60H 1/3421; B60H 2001/3471; B60H 2001/3464

(57) ABSTRACT

An air vent for a vehicle includes a housing and a plurality of air-guiding slats mounted movably in the housing and which serve for diverting air flowing through the housing. A plurality of throttling slats are arranged upstream of the air-guiding slats in a flow direction of air through the housing, the throttling slats being mounted pivotably between an open position, which permits an air flow through the housing, and a closed position, which blocks an air flow through the housing. The throttling slats have in each case slat surfaces which are situated opposite one another and which are connected on the longitudinal sides of the throttling slats by in each case one slat tip, wherein the throttling slats have shape elements on their slat surfaces, the shape elements of neighboring throttling slats engaging into one another in a sealing manner in the closed position.

### TECHNICAL FIELD

The invention relates to an air vent for a vehicle, comprising a housing and a plurality of air-guiding slats which are mounted movably in the housing and which serve for diverting air flowing through the housing, with a plurality of throttling slats which are arranged upstream of the air-guiding slats in the flow direction of the air through the housing, the throttling slats being mounted pivotably between an open position, which permits an air flow through the housing, and a closed position, which blocks an air flow through the housing, and the throttling slats having in each case slat surfaces which are situated opposite one another and which are connected on the longitudinal sides of the throttling slats by in each case one slat tip.

### BACKGROUND

Air vents of the type mentioned above serve to direct an air flow into a vehicle interior, for example of a passenger car or truck. A housing of the air vent defines a flow path for the air. Air-guiding slats mounted in an adjustable manner in the housing can be actuated for example manually in order to guide the air flow into the vehicle interior in the desired direction. Throttling slats are furthermore provided in order to control the amount of air guided into the vehicle interior, and in particular to block it as much as possible in a closed position.

An air vent is known for example from DE 298 14 953 U1. In order to improve the sealing action against air flowing through in the closed position, control flaps are provided in that air vent, which have a sealing lip made of a plastics material that is softer than a main body of the control flaps. However, it is complicated and expensive to produce such control flaps formed from two different material components.

A further air vent is known from DE 10 2012 022 364 A1. In that case, front slats that directly face the vehicle interior serve to control the amount of air and in particular to block the air flow in a closed position. In order to provide a sealing action against the air flow, profile end portions of neighboring stats are able to be brought into engagement with one another in a form-fitting manner in the closed position. To this end, the profile end portions, forming the slat tips, of the slats can in each case have at least one projection or at least one recess corresponding thereto. However, with that air vent, it is not possible achieve effective sealing off of the air flow in practice, inter alia because of unavoidable production and mounting tolerances of the slats, in particular of the thin slat tips, and resultant insufficient sealing off of neighboring slats in the closed position. Also, at the interface between slats and housing, satisfactory sealing is not realized in practice in the case of that known air vent.

### SUMMARY

Proceeding from the outlined prior art, the invention is therefore based on the object of providing an air vent of the type mentioned at the beginning, with which a better sealing action against the air flow in the closed position of the throttling slats is achieved in a simple manner in terms of production and taking unavoidable production and mounting tolerances into account.

For an air vent of the type mentioned at the beginning, the invention achieves the object in that the throttling slats have shape elements on their slat surfaces, the shape elements of neighboring throttling slats engaging into one another in a sealing manner in the closed position.

The air vent according to the invention serves to direct fresh air into a vehicle interior, for example of a passenger car or truck. The air-guiding slats can be mounted for example pivotably in the housing. They direct the air flow into the vehicle interior in the desired direction depending on their orientation, which is controllable for example manually. The throttling slats which are also provided in the air vent according to the invention serve to set the amount of air flow, in particular as far as completely blocking the air flow in the closed position. The throttling slats, too, can be involved in diverting the air in the desired direction. The throttling slats are mounted in the housing so as to be pivotable between an open position, in which they permit the maximum air flow through the housing, and a closed position, in which they block the air flow to the maximum extent. In the closed position, they can rest against one another in particular in the manner of roof tiles and seal off the flow path formed through the housing. In order to be mounted pivotably, the throttling slats can have for example pivot pins which are inserted in corresponding pin receptacles in the housing or in a frame of the housing. The same goes in principle for the air-guiding slats.

In the air vent according to the invention, the throttling slats are located upstream of the air-guiding slats, i.e., as seen from the vehicle interior, behind the air-guiding slats. The throttling slats have opposite (upper and lower) slat surfaces, over and under which, respectively, the air flow flows in the open position. Via slat tips, the slat surfaces are connected together lengthwise. It goes without saying that the slat tips do not have to be formed in a pointed manner, but rather can be for example rounded or have other geometries. The slat tips can be characterized by a cross section that decreases with respect to the slat surfaces. The long sides and thus the slat tips of the throttling slats can extend in the direction of, for example parallel to the pivot axis of the throttling slats. This configuration of the throttling slats can in principle also be provided in the air-guiding slats.

According to the invention, the throttling slats have shape elements on their slat surfaces. The shape elements of neighboring throttling slats engage into one another in a sealing manner, in particular in a form-fitting manner, in the closed position. The shape elements can thus be form-fitting elements. As a result, improved sealing is achieved in the closed position of the throttling slats. Given that the shape elements are formed according to the invention on the slat surfaces, and not at the slat tips, the sealing action is improved, since, on account of unavoidable production and mounting tolerances, the throttling slats do not bear reliably against one another in the region of their usually thin slat tips. Shape elements positioned there, as are provided in the prior art outlined at the beginning, therefore do not ensure reliable sealing in practice. This is avoided according to the invention in that the shape elements are formed in the region of the slat surfaces. Preferably, the shape elements are in this case also not formed immediately adjacent to the slat tips, but rather portions of the slat surfaces also extend between the shape elements and the slat tips. The shape elements provided according to the invention that engage into one another form a labyrinth for the air flow, thereby further improving the sealing action.

One reason why the shape elements are formed at the slat tips in the prior art outlined at the beginning is the visual appearance. Thus, the shape elements necessary for the sealing action are less conspicuous and intrusive in the region of the slat tips. However, this does not represent a problem according to the invention, since, in the case of the air vent according to the invention, unlike in the prior art outlined at the beginning, the throttling slats the ensure the sealing action are arranged upstream of the air-guiding slats, and are thus not visible or are less visible from the vehicle interior since they are concealed by the air-guiding slats located in front of them.

With the air vent according to the invention, the sealing action against the air flow in the closed position can be significantly improved compared with known air vents. Known air vents have for example, at a pressure load of 200 Pa, air leakage values of more than 6 kg/h in the closed position. With the air vent according to the invention, much better leakage values can be achieved. At the same time, the air vent according to the invention is distinguished by simple production and mounting. In particular, no complicated throttling slats made of several material components are required for the improved sealing action.

According to one configuration, the throttling slats can have, as shape elements, in each case at least one sealing groove extending over the entire length of a slat surface and at least one sealing projection extending over the entire length of the opposite slat surface, the sealing projections and sealing grooves of neighboring throttling slats engaging into one another in a sealing manner in the closed position. The sealing grooves and sealing projections are formed in a manner corresponding to one another, such that they can engage optimally into one another. Given that they extend over the entire length of the throttling slats, full sealing is achieved. For example, each throttling slat can have exactly one sealing groove on one of its slat surfaces and exactly one sealing projection on its opposite slat surface. The throttling slats engaging into one another in this way can thus be formed identically in a particularly simple manner in terms of production.

The sealing projections can have in each case a trapeziform cross section, and/or the sealing grooves can have in each case a trapeziform cross section. As a result, the sealing effect is further improved. The respectively straight trapezoid surfaces can be connected together by curved surfaces, i.e. radii, with the result that the engagement into one another and thus the sealing effect are ensured, taking unavoidable production and mounting tolerances into account. In particular, such tolerances are optimally compensated with this configuration. However, other shape-element geometries are also possible, of course.

According to a further configuration, in the closed position, the throttling slats bear against one another only in the region of their shape elements. Thus, the slat surface portions which border the shape elements and with which neighboring throttling slats can overlap in particular in the manner of roof tiles in the closed position, do not touch in the closed position. Rather, sealing contact takes place only in the region of the shape elements. As a result, the sealing action is further improved. In particular, further improved compensation of production and mounting tolerances occurs, since contact has to be ensured only in the region of the shape elements.

According to a further configuration, the housing has a housing main body and a frame which is inserted into the housing main body and against which the throttling slats bear in the closed position. According to a further configuration, the frame can be formed in one piece. The frame can for example be injection molded in the housing main body in a plastics injection-molding process. However, it can also be produced as a separate component and be fastened in the housing main body, for example by latching. In particular a one-piece frame reduces the number of component interfaces to be sealed off in the closed position, compared with the frames of multipart construction that are frequently provided in the prior art. Thus, in the case of a one-piece frame, there is only one interface between the throttling slats and between the throttling slats and the frame. The sealing action can thus be improved further.

However, a multipart frame, which consists of individual parts, would also be conceivable. In this case, the sides which form the pivot bearings for the throttling slats could form bearing strips with corresponding formations for the sealing action. Shape elements formed on the frame could likewise be individual parts. Also conceivable is an embodiment with bearing strips, in the case of which the shape elements would be part of the housing. A two- or multipart frame that is plugged together would also be conceivable.

The frame can consist of a different material than the throttling slats and/or of a different material than the housing main body. For example, a softer material than for the housing main body and/or the throttling slats would be conceivable for the frame, for example with a deformable sealing geometry. This would have an advantageous effect on the tolerance compensation between the throttling slats and frame and between the frame and housing main body. Such a configuration would also be advantageous with regard to undesired noise generation (caused for example by individual hard-plastics components rubbing against one another), or the reduction thereof.

On the frame, it is likewise possible for shape elements to be provided, preferably sealing grooves and/or sealing projections, which engage, in the closed position, in a sealing manner into shape elements of the throttling slats bearing against the frame. As a result, the sealing action between the throttling slats and the frame is improved. The shape elements on the frame in this case correspond to the shape elements of the throttling slats bearing against the frame. The shape elements can be corresponding sealing grooves and/or sealing projections, preferably trapeziform sealing grooves and/or trapeziform sealing projections, as outlined above. For example, shape elements can continue into the frame from throttling slats, for example sealing grooves or sealing projections, on the transverse sides of the throttling slats. The shape elements in the frame then thus form a lateral extension of the shape elements of the throttling slats. The next throttling slat thus bears with its respective shape element on the shape element of the neighboring throttling slat on one side and on the corresponding shape element of the frame on the other side. To this end, the throttling slats can have asymmetric slat surfaces, for example slat surfaces that are stepped in the longitudinal direction. The abovementioned shape elements can be formed in particular on the end sides of the frame, on which the throttling slats are mounted pivotably, for example with the pivot pins outlined above. The corresponding pin receptacles can then be formed in the frame. It is also possible, additionally or alternately, for corresponding shape elements to be provided on the end sides of the frame, on which the throttling slats are not mounted pivotably. Said shape elements can then extend over the entire frame width, wherein in each case the throttling slats directly neighboring the frame come into engagement with the shape elements, extending in this case preferably over the entire length of the throttling slats, in a sealing manner in the closed position.

The frame can have at least one step in the flow direction of the air through the housing. Such a step forms a further constituent part of the labyrinth blocking the air flow. The step forces the air into a for example twofold deflection through 90°, with the result that the sealing is further improved. A configuration with several steps is also possible. For example, additional steps can be formed by one or more steps in the respective throttling slat and corresponding steps on the frame portion, against which this throttling slat bears in the closed position. As a result of such a multistep configuration, the path of the air through the labyrinth formed by the steps is extended and a further improved sealing effect is achieved.

According to a further configuration, one of the throttling slats can be provided as an actuating slat for actuating the remaining throttling slats, said slat being connected both to an actuating mechanism for manual or motorized, for example electromotive, actuation and to a coupling element, for example a coupling rod, which is coupled to the other throttling slats. In the closed position, the actuating slat can be covered at least partially by a cover slat, wherein the cover slat and the actuating slat have shape elements which engage into one another in a sealing manner in the closed position. The actuating slat and the cover slat thus in particular likewise form throttling slats. Otherwise, the actuating slat and optionally the cover slat in turn has shape elements, with which throttling slats adjacent thereto are engaged in a sealing manner in the closed position. These shape elements can in turn be configured as outlined above. The shape elements on the actuating and cover slats also correspond to one another. They can be formed like the other shape elements, as outlined above. The shape elements of the actuating and cover slats can furthermore extend for example along a singly or multiply curved line. This further improves the labyrinth effect and thus the sealing action.

As already outlined, the throttling slats, including the actuating slat and optionally a cover slat, can be composed of a uniform material. In this configuration, the throttling slats thus form in particular no two-component parts. This results in particularly simple production, since no separate sealing elements made of a different material are necessary. It is also possible for some or all of the throttling slats to each be composed of a uniform material, but for the material of at least some throttling slats to differ from one another. As a result, it is possible, for example, for different stiffness of the throttling slats to be achieved.

### BRIEF DESCRIPTION OF THE DRAWINGS

An exemplary embodiment of the invention is explained in more detail in the following text with reference to figures, in which, schematically:

FIG. 1 shows a front view of a part of an air vent according to the invention,

FIG. 2 shows a cross-sectional view of a throttling slat of the air vent shown in FIG. 1,

FIG. 3 shows a perspective partial view of the throttling slat shown in FIG. 2,

FIG. 4 shows a further perspective detail view of the throttling slat shown in FIG. 2,

FIG. 5 shows a sectional view along the line A-A in FIG. 1,

FIG. 6 shows an enlarged illustration of the detail C shown in FIG. 5,

FIG. 7 shows a sectional view along the line B-B in FIG. 1,

FIG. 8 shows an enlarged illustration of the detail D shown in FIG. 7,

FIG. 9 shows a perspective rear view of the frame of the air vent shown in FIG. 1,

FIG. 10 shows an enlarged perspective illustration of a detail of the frame from FIG. 9 with a throttling slat arranged therein,

FIG. 11 shows a sectional view through the frame detail in FIG. 10 with a further throttling slat mounted on the frame, and

FIG. 12 shows an enlarged illustration of the right-hand edge, in FIG. 9, of the frame.

Unless specified otherwise, identical reference signs in the figures denote identical items.

### DETAILED DESCRIPTION

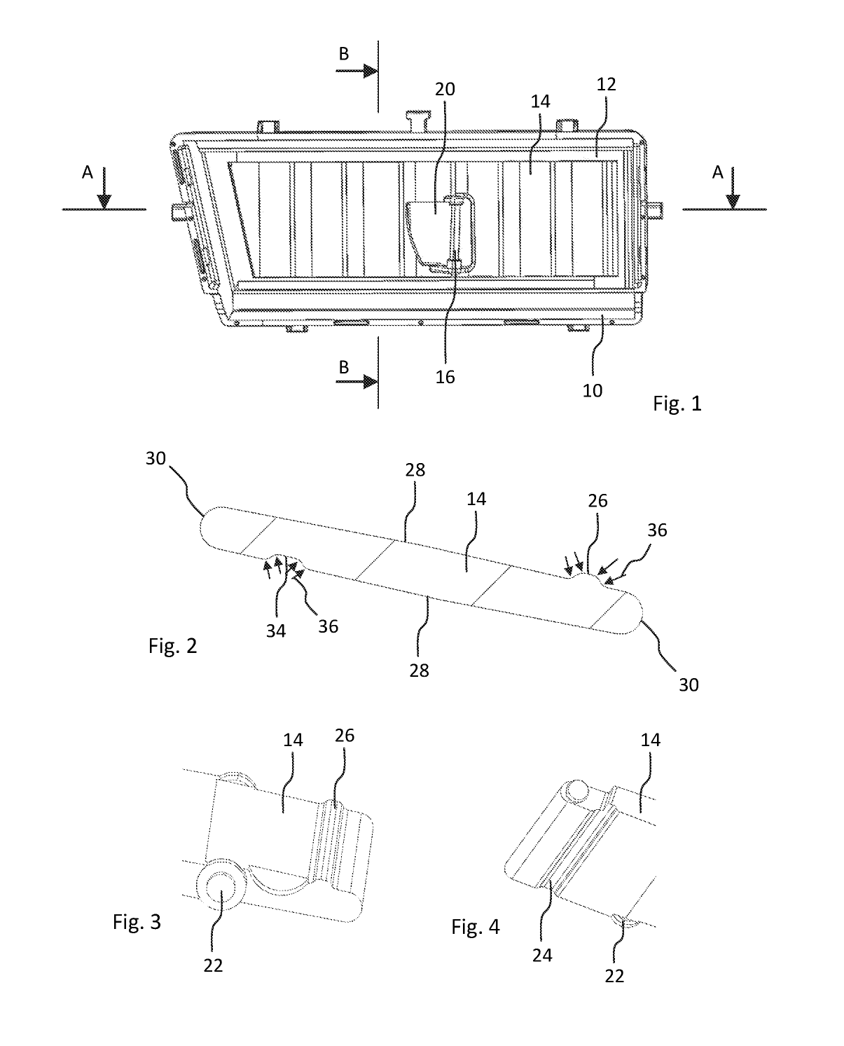

The air vent according to the invention that is shown in FIG. 1 has a housing main body 10 and a one-piece frame 12 inserted into the housing main body 10. Pivotably mounted in the frame 12 are a plurality of throttling slats 14. In FIG. 1, the pivot axes of the throttling slats 14 extend from top to bottom. In this case, FIG. 1 shows the closed position of the throttling slats 14, in which the latter rest against one another in the manner of roof tiles, as can be seen in particular in the sectional illustration in FIG. 5. In the example shown, a for example manually actuable actuating slat 16 is connected to the rest of the throttling slats 14 in a manner known per se via a coupling rod that is concealed in FIG. 1. As a result of for example manual actuation of the actuating slat 16, the throttling slats 14 can be pivoted between the closed position, shown in FIGS. 1 and 5, in which they block an air flow through the housing, and an open position, which permits an air flow through the housing to the maximum extent. In order to actuate the actuating slat 16, a hand wheel or a sliding knob for example, which can be guided for example on one of the air-guiding slats, can be provided in a manner known per se. In FIG. 5, the air flow leading into the vehicle interior is illustrated by the arrow 18. The actuating slat 16 is furthermore covered by a cover slat 20, which, in the closed position, ensures the sealing action with respect to the air flow together with the rest of the throttling slats 14.

It goes without saying that the air vent furthermore has air-guiding slats which are not illustrated in the figures for reasons of clarity and are likewise mounted pivotably in the housing, and with which the air flow can be diverted into the vehicle interior in the desired manner. In the example shown, the throttling slats 14, including the actuating slat 16 and the cover slat 20, are located upstream of the air-guiding slats as seen in the direction of flow of the air. As seen from the vehicle interior, the throttling slats 14 and the actuating slat 16 and cover slat 20 are thus concealed by the air-guiding slats. This configuration of the air-guiding slats, and in particular the pivotable mounting thereof in the housing, is known per se and will therefore not be explained in more detail.

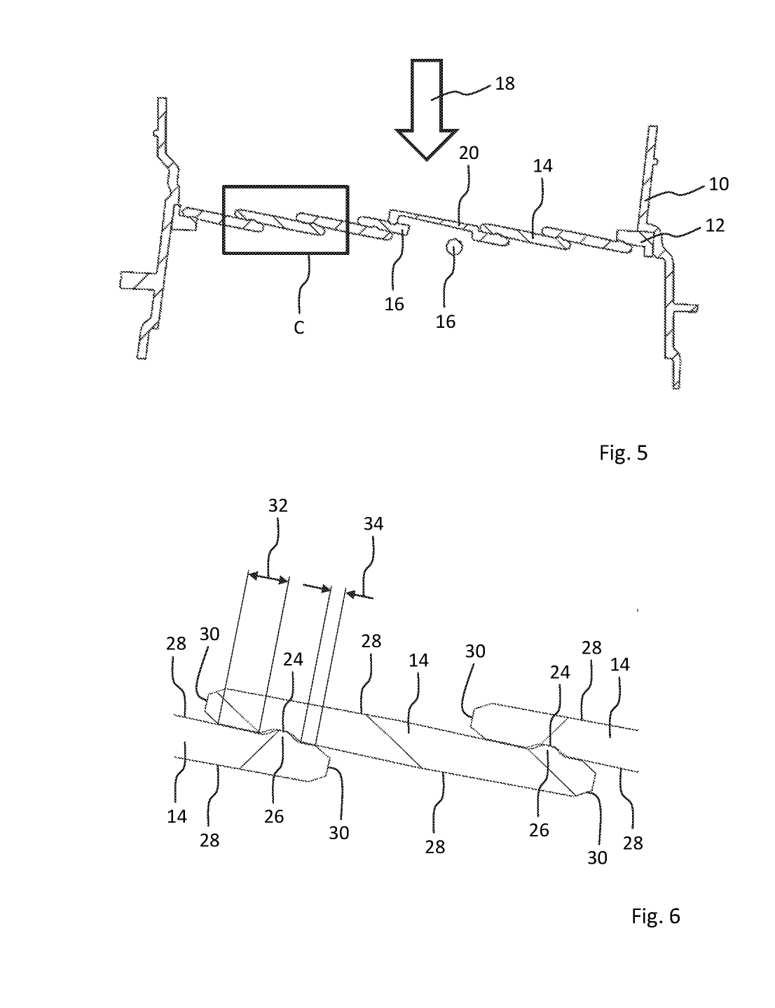

In particular in the illustrations in FIGS. 3 and 4, pivot pins 22 of the throttling slats 14 are apparent, which are mounted pivotably in corresponding pin receptacles in the frame 12 in the mounted state. The same goes for the actuating and cover slats 16, 20. FIGS. 3 and 4 in this case show, in different details, a throttling slat 14 as is shown in a sectional illustration in FIG. 2. In this case, it is apparent that the illustrated throttling slat 14 (the rest of the throttling slats 14 being configured in an identical manner) has a cross-sectionally trapeziform sealing groove 24 and a cross-sectionally trapeziform sealing projection 26 formed in a corresponding manner. In the closed position, the sealing projections 26 and sealing grooves 24 of neighboring throttling slats 14 engage into one another in a sealing, in particular form-fitting manner, as is apparent in particular from FIGS. 5 and 6. In this case, the neighboring throttling slats 14 are in contact with one another only in the region of their sealing grooves 24 and sealing projections 26. It should also be noted here that the throttling slats 14 in each case have mutually opposite slat surfaces 28, which are connected together on the long sides of the throttling slats 14 by slat tips 30. It should furthermore be noted that, in particular in FIG. 6, the slat tips are illustrated in a trapeziform manner and not in a round manner, as in FIGS. 2 to 4, for illustrative reasons. In fact, the slat tips of all the throttling slats 14 are formed in an identical manner. It is also apparent that the sealing grooves 24 and sealing projections 26 are formed in each case in the region of the slat surfaces 28 and are at a distance from the slat tips 30. Thus, mutually overlapping portions 32, 34, shown in FIG. 6 at the reference signs 32 and 34, of the slat surfaces 28 arise. According to the invention, in the region of these overlapping portions 32, 34, there is no contact between neighboring throttling slats 14, but rather such contact occurs only in the region of the sealing grooves 24 and sealing projections 26. It should furthermore be noted that the straight surfaces of the trapezoid cross-sectional shape of the sealing grooves 24 and sealing projections 26 are connected together in each case by curved regions, as illustrated by the arrows 36 in FIG. 2. In FIG. 7, the coupling rod 38 that couples the different throttling slats 14 to the actuating slat 16 is furthermore apparent at the reference sign 38. The actuating slat 16 and the cover slat 20 otherwise have sealing grooves 24 and sealing projections 26 which are formed likewise in a corresponding manner and with which they bear both against one another and against the neighboring throttling slats 14, as is apparent from FIG. 5.

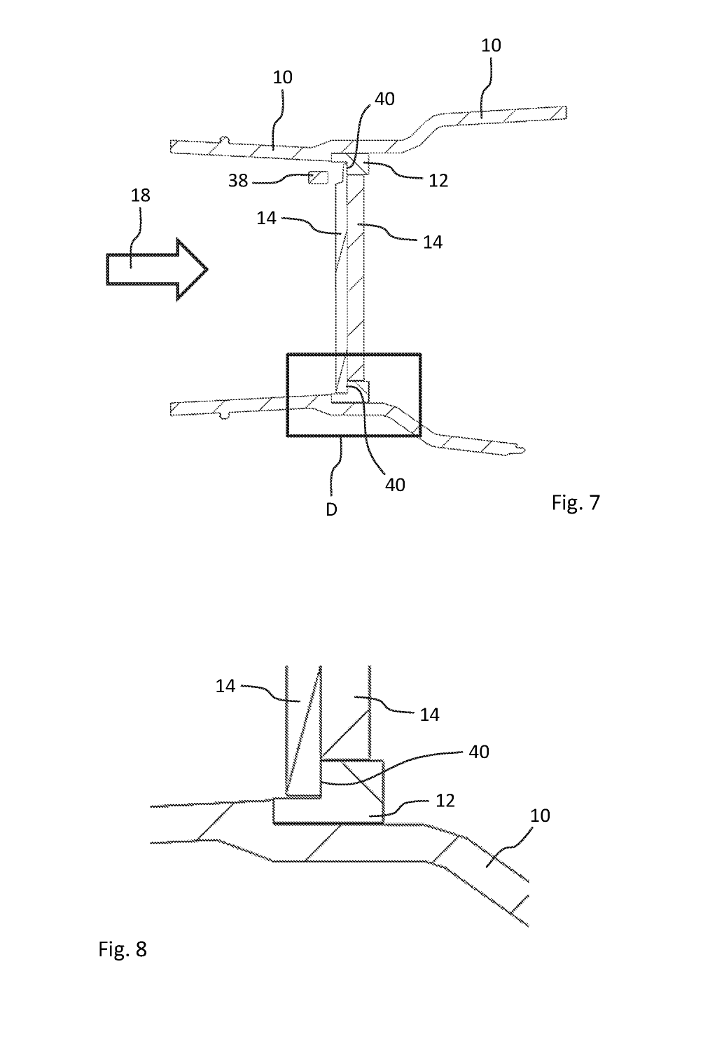

It is furthermore apparent from FIG. 8 that the frame 12 forms in each case a step 40 on opposite sides, top and bottom in FIG. 7, said step being brought as close as possible to the throttling slats 14 and resulting in further necessary diversion of air flowing past beneath and above the throttling slats 14 and thus in a further improved sealing at this interface between the throttling slats 14 and the frame 12.

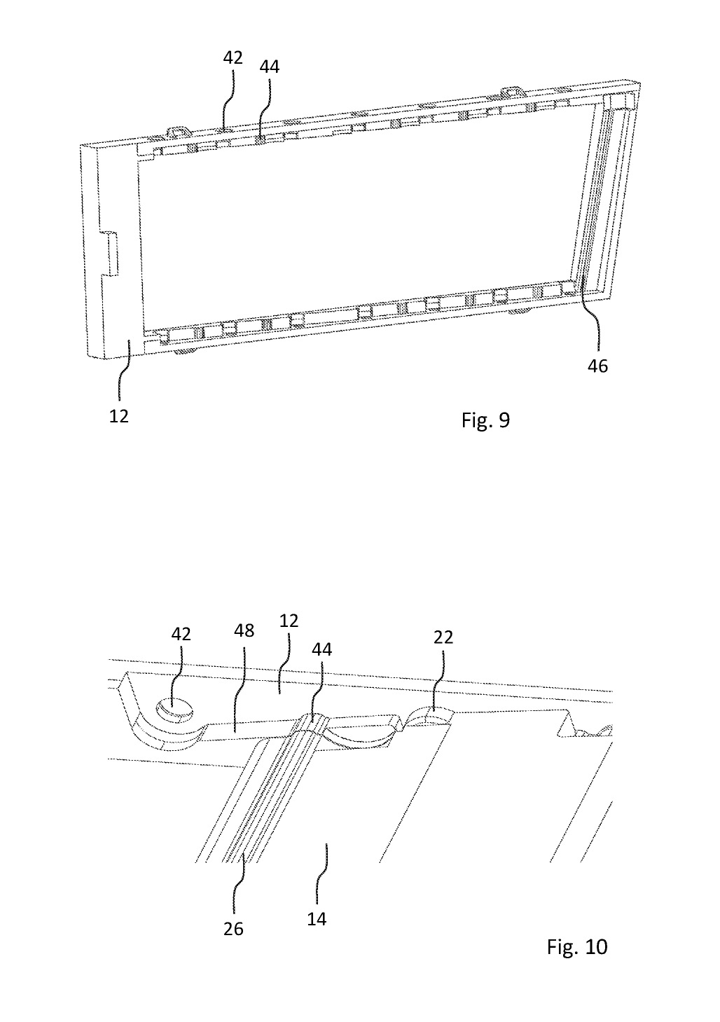

In FIG. 9, pin receptacles 42 for the pivot pins 22 of the throttling slats 14 are apparent. Of course, corresponding pin receptacles 42 for corresponding pivot pins are also provided for the actuating slat 16 and the cover slat 20. Furthermore, it should be noted that, although a separate formation of actuating slat 16 and cover slat 20 is shown in the figures, a combined, one-piece actuating and cover slat would also be conceivable.

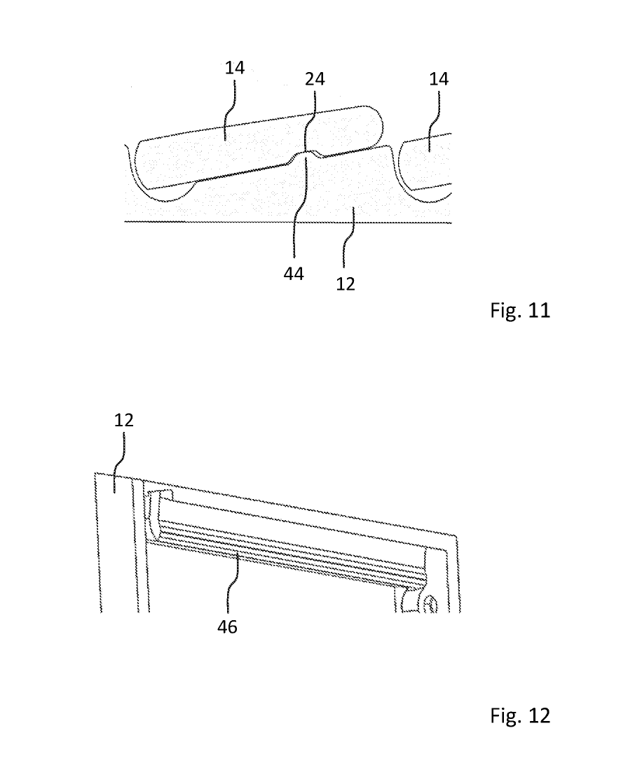

It is apparent from FIGS. 9 and 10 that the frame 12 has in each case a plurality of sealing projections 44 on its sides that support the throttling slats 14, the top and bottom side in FIG. 9, said sealing projections 44 corresponding to the sealing projections 26 of the throttling slats 14 in terms of their cross section. As shown in FIG. 10 by way of example for a throttling slat 14, the sealing projections 44 of the frame 12 form lateral extensions of the sealing projections 26 of the throttling slats 14 located in the closed position. In order to illustrate this, the throttling slat 14 that is actually mounted pivotably in the visible pin receptacle 42 is not illustrated in FIG. 10. However, it is shown in the sectional illustration in FIG. 11. It is apparent from FIG. 11 in conjunction with FIGS. 5 and 6 that the throttling slats 14 in each case rest in a sealing manner on the sealing projections 26 of the neighboring throttling slats 14 and on the corresponding sealing projections 44 of the frame 12. To this end, the throttling slats 14 have an asymmetric configuration. Furthermore, the frame 12 has inclined surfaces 48 between the pin receptacles 42 and the sealing projections 44, on which the throttling slats 14 can rest in each case in the closed position. Thus, optimal sealing is achieved even at this interface with respect to the frame 12. It should also be noted that sealing grooves that correspond to the sealing projections of the throttling slats 14 can of course also be provided alternately or additionally on the frame 12.

The frame 12 furthermore also has shape elements on its transverse sides that do not support the throttling slats 14, the left-hand and right-hand side in FIG. 9. On one transverse side, the left-hand transverse side in FIG. 9, the frame 12 has a sealing groove that corresponds to the sealing grooves 24, extends over the entire width of the frame 12 and is concealed by the frame 12. On its other transverse side, the right-hand transverse side in FIG. 9, the frame 12 has a sealing projection 46 that corresponds to the sealing projections 26 of the throttling slats 14. This is readily apparent even in the enlarged partial illustration in FIG. 12. In the closed position, the transverse sides of facing terminal throttling slats 14 rest in a corresponding manner with their sealing groove 24 or their sealing projection 26 on the corresponding sealing projection 46 of the frame 12 or the corresponding sealing groove of the frame 12, respectively, such that, even at this interface between the throttling slats 14 and frame 12, optimal sealing is achieved in the closed position.

### LIST OF REFERENCE SIGNS

10 Housing main body
12 Frame
14 Throttling slats
16 Actuating slat
18 Air flow
20 Cover slat
22 Pivot pin
24 Sealing groove
26 Sealing projection
28 Slat surface
30 Slat tip
32 Overlapping portions
34 Overlapping portions
36 Arrows
38 Coupling rod
40 Step
42 Pin receptacle
44 Sealing projection
46 Sealing projection
48 Inclined surface

What is claimed is:

1. An air vent for a vehicle, comprising a housing and a plurality of air-guiding slats which are mounted movably in the housing and which serve for diverting air flowing through the housing, further comprising a plurality of throttling slats (14) which are arranged upstream of the air-guiding slats in a flow direction of air through the housing, the throttling slats (14) being mounted pivotably between an open position, which permits air flow (18) through the housing, and a closed position, which blocks air flow (18) through the housing, and the throttling slats (14) having in each case slat surfaces (28) which are situated opposite one another and which are connected on longitudinal sides of the throttling slats (14) by in each case one slat tip (30), wherein the throttling slats (14) have shape elements on their slat surfaces (28), the shape elements of neighboring throttling slats (14) engaging into one another in a sealing manner in the closed position.

2. The air vent as claimed in claim 1, wherein the throttling slats (14) have, as shape elements, in each case at least one sealing groove (24) extending over an entire length of a slat surface (28) and at least one sealing projection (26) extending over an entire length of the opposite slat surface (28), the sealing projections (26) and sealing grooves (24) of neighboring throttling slats (14) engaging into one another in a sealing manner in the closed position.

3. The air vent as claimed in claim 2, wherein the sealing projections (26) have in each case a trapeziform cross section, and/or wherein the sealing grooves (24) have in each case a trapeziform cross section.

4. The air vent as claimed in claim 2, wherein, in the closed position, the throttling slats (14) bear against one another only in the region of their shape elements.

5. The air vent as claimed in claim 1, wherein the housing has a housing main body (10) and a frame (12) which is inserted into the housing main body (10) and against which the throttling slats (14) bear in the closed position.

6. The air vent as claimed in claim 5, wherein the frame (12) is formed in one piece.

7. The air vent as claimed in claim 5, wherein on the frame (12) there are likewise formed shape elements, into which the shape elements of the throttling slats (14) bearing against the frame (12) engage in a sealing manner in the closed position.

8. The air vent as claimed in claim 5, wherein the frame (12) has at least one step (40) in the flow direction of the air through the housing.

9. The air vent as claimed in claim 1, wherein one of the throttling slats is provided as an actuating slat (16) for actuating the remaining throttling slats (14), said actuating slat (16) being connected both to an actuating mechanism for manual or motorized actuation and to a coupling element which is coupled to the other throttling slats (14).

10. The air vent as claimed in claim 9, wherein, in the closed position, the actuating slat (16) is at least partially covered by a cover slat (20), wherein the cover slat (20) and the actuating slat (16) have shape elements which engage into one another in a sealing manner in the closed position.

11. The air vent as claimed in claim 1, wherein the throttling slats (14) are composed of a uniform material.

12. An air vent for a vehicle, comprising a housing and a plurality of air-guiding slats which are mounted movably in the housing and which serve for diverting air flowing through the housing, further comprising a plurality of throttling slats which are arranged upstream of the air-guiding slats in a flow direction of air through the housing, the throttling slats being mounted pivotably between an open position, which permits air flow through the housing, and a closed position, which blocks air flow through the housing, and the throttling slats having in each case first and second slat surfaces which are situated opposite one another and which are connected on longitudinal sides of the throttling slats by, in each case, one slat tip, wherein each throttling slat has a respective first shape element on its first slat surface and a second shape element on its second slat surface, the first shape element of one throttling slat shaped to engage into the second shape element of an adjacent throttling slat in a sealing manner when the throttling slats are in the closed position.

13. The air vent as claimed in claim 12, wherein each throttling slat has, as the first shape element, at least one sealing groove extending over an entire length of its first slat surface, and, as the second shape element, at least one sealing projection extending over an entire length of its second slat surface.

14. The air vent as claimed in claim 13, wherein each sealing projection has a trapeziform cross section, and wherein each sealing groove has a trapeziform cross section.

15. The air vent as claimed in claim 13, wherein, when the throttling slats are in the closed position, each throttling slats bear against any adjacent throttling slot only in a region of aligned first and second shape elements.

16. The air vent as claimed in claim 12, wherein the housing has a housing main body and a frame that is inserted into the housing main body and against which the throttling slats bear when the throttling slats are in the closed position.

17. The air vent as claimed in claim 16, wherein the frame has at least one step in the flow direction of air through the housing.
